(19) United States
(12) Patent Application Publication
(10) Pub. No.: US 2009/0107958 A1
(43) Pub. Date: Apr. 30, 2009

(54) Torch and Contact Tip for Gas Metal Arc Welding

(75) Inventor: Alexander D. Khakhalev, TROY, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBALTECHNOLOGY OPERATIONS, INC., DETROIT, MI (US)

(21) Appl. No.: 11/924,806

(22) Filed: Oct. 26, 2007

(51) Int. Cl. B23K 9/16

(52) U.S. Cl. 219/74

(57) ABSTRACT

A torch for gas metal arc welding includes a torch housing and a contact tip mounted on the housing and having an electrode bore through which electrode wire is fed. A nozzle mounted on the housing surrounds the contact tip to define an annular gas passage between the contact tip and the inside of the nozzle. A shielding gas inlet communicates a shielding gas into the annular gas passage so that the shielding gas flows out of the nozzle. A plurality of auxiliary flow passages are provided in the contact tip, and have open ends arranged around the electrode bore. The auxiliary flow passages communicate with the gas inlet and surround the electrode wire with an auxiliary flow of shielding gas that is closer to the electrode wire than the shielding gas flow that is provided through the annular gas passage between the contact tip and the nozzle.

### FIELD OF THE INVENTION

The present invention relates to a torch for gas metal arc welding and more particularly a torch and contact tip providing improved flow of shielding gas to reduce weld spatter onto the torch.

### BACKGROUND OF THE INVENTION

Gas metal arc welding is an arc welding process in which a continuous and consumable wire electrode is fed through a contact tip of the welding torch. A nozzle surrounds the contact tip. A constant voltage direct current power source produces an arc between the continuously fed wire electrode and the workpiece to create a molten weld pool. Shielding gas, such as Argon, is ducted through the torch between the nozzle and contact tip to protect the weld pool from atmospheric gases such as nitrogen and oxygen which can cause fusion defects, porosity, and weld metal embrittlement.

One problem with the aforedescribed gas metal arc welding process is that weld spatter can build up on the nozzle and on the contact tip, thereby disturbing the flow of shielding gas, disturbing the smooth feeding of the electrode wire into the weld pool, and/or disturbing the weld arc and otherwise influencing weld quality.

Accordingly, it would be desirable to provide improvements in the torches and contact tips for gas metal arc welding to reduce the occurrence of spatter buildup on the welding torch and contact tip.

### SUMMARY OF THE INVENTION

According to the invention, a torch for gas metal arc welding includes a torch housing and a contact tip that is mounted on the housing and has an electrode bore through which an electrode wire is continuously fed toward the workpiece. A nozzle mounted on the torch housing surrounds the contact tip in spaced relation therefrom to define an annular gas passage between the outer surface of the contact tip and the inside of the nozzle. A shielding gas inlet provided in the housing communicates a shielding gas such as argon into the annular gas passage so that the shielding gas flows out of the nozzle and toward the work piece. A plurality of auxiliary flow passages are provided in the contact tip and have open ends arranged around the electrode bore. The auxiliary flow passages communicate with the gas inlet and surround the electrode bore of the contact tip with a flow of shielding gas that is closer to the electrode wire than the shielding gas flow that is provided through the annular gas passage between the contact tip and the nozzle.

### BRIEF DESCRIPTION OF THE DRAWINGS

The present invention will become more fully understood from the detailed description and the accompanying drawings, wherein:

FIG. 1 is a elevation view, having parts broken away and in section through a prior art welding torch showing the flow of shielding gas around the contact tip and wire electrode;

FIG. 2 is a fragment of FIG. 1 showing a typical buildup of weld spatter on the contact tip and nozzle;

FIG. 3 is an elevation view similar to FIG. 1 and showing a first embodiment of the invention;

FIG. 4 is a sectional view taken in the direction of arrows 4-4 of FIG. 3;

FIG. 5 is a view similar to FIG. 3 but showing another embodiment of the invention; and

FIG. 6 is a section view taken in the direction of arrows 6-6 of FIG. 5.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### DETAILED DESCRIPTION OF THE EXEMPLARY EMBODIMENTS

The following description of certain exemplary embodiments is exemplary in nature and not intended to limit the invention, its application, or uses.

FIG. 1 is a section view through a conventional torch used in gas metal arc welding. The torch, generally indicated at 10, includes a housing 12 which mounts a contact tip 16. The housing 12 can be attached to a torch handle, not shown, that is manipulated by the weld operator, or the housing 12 may be manipulated by a robot or other mechanical manipulator. As seen in FIG. 1, the housing 12 supports the contact tip 16 above workpieces 24 and 26 that are to be welded together. The contact tip 16 is generally cylindrical in shape and includes a cylindrical outer surface 30 and a circular end face 32. An electrode bore 36 extends axially through the contact tip 16. The contact tip 16 is conventionally made of an electrically conductive material such as copper. The contact tip 16 is electrically connected to a source of welding current 20.

An electrode wire 42 extends through the electrode bore 36 of the contact tip 16 and through the end face 32 of the contact tip 16 to closely approach the workpieces 24 and 26. The electrical current present at the contact tip 16 is conducted into the electrode wire 42, causing an arc 46 between the end of the electrode wire 42 and the workpieces 24 and 26. The electrode wire 42 is melted into the arc 46 and mixes with molten material from the workpieces 24 and 26 to form a weld pool 48. The electrode wire 42 is stored on a reel and fed into the contact tip 16 to replenish the electrode wire 42 as it is consumed by being melted into the weld pool 48.

FIG. 1 also shows a nozzle assembly 50 that surrounds the contact tip 16. The nozzle assembly 50 is generally tubular in shape and attached to the torch housing 12 via a plastic insulator 52 and a retainer ring 54 so that the nozzle assembly 50 is electrically insulated from the housing 12. The nozzle assembly 50 has a plastic nozzle liner insert 55 that defines an inside wall surface 56 of the nozzle assembly 50 and is spaced away from the housing 12 and the outer surface 30 of the contact tip 16 so that an annular flow passage 58 is provided between the outer surface 30 of the contact tip 16 and the inside wall surface 56 of the nozzle assembly 50. Nozzle assembly 50 has an open lower end 59 that allows the electrode wire 42 and the shielding gas to be directed at the workpieces.

FIG. 1 also shows that a gas inlet aperture 60 is provided in the housing 12. The gas inlet 60 is suitably connected with a tank 64 or other supply of shielding gas. Shielding gas is provided to the gas inlet 60 and through radial passages 68 and 70 into the annular flow passage 58 extending between the nozzle assembly 50 and housing 12, and between the nozzle assembly 50 and the contact tip 16.

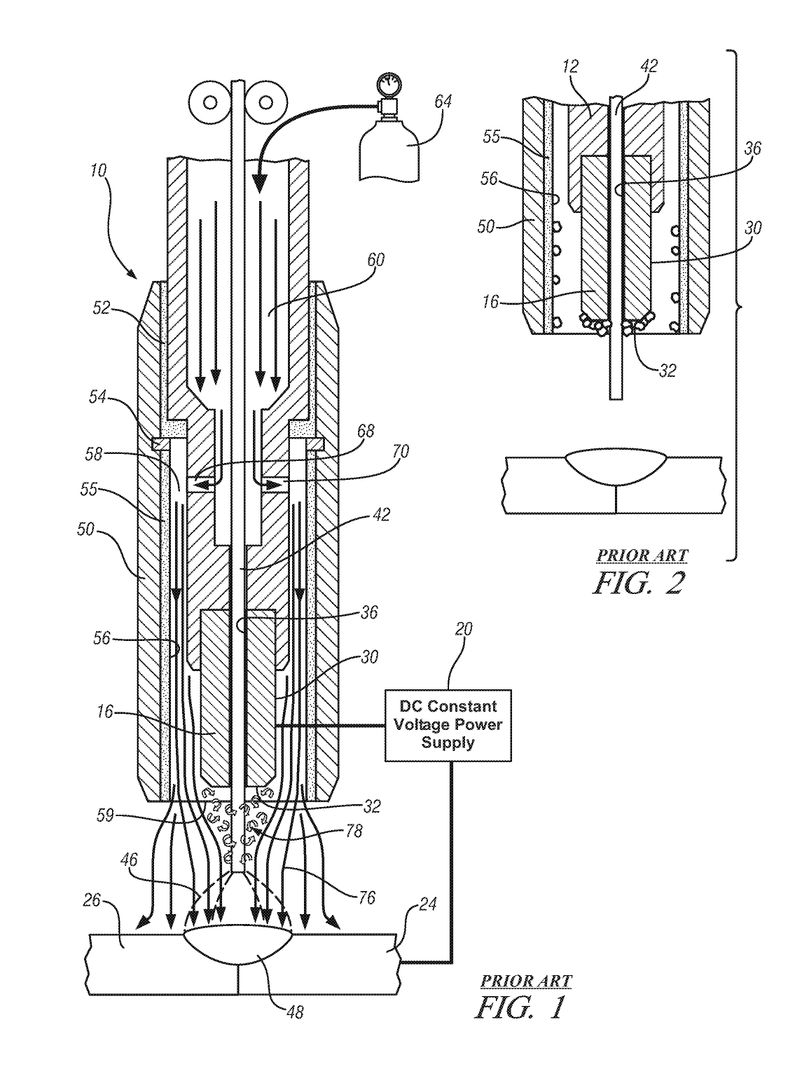

FIG. 2 shows a typical buildup of weld spatter onto the nozzle and contact tip 16 during the welding process. This spatter is known to accumulate and adversely impact the weld quality. From time to time, the welding process must be stopped in order to clean the contact tip 16 and nozzle assembly 50, in some cases requiring removal and replacement.

As best illustrated in FIG. 1, the flow of shielding gas is principally along the several paths indicated by the arrows 76, and this flow induces the occurrence of vortices 78. These vortices 78 occur within an area of low pressure that exists generally in the region around the end face 32 of the contact tip 16. These vortices 78 and the low pressure environment serve as an attractor for weld spatters and enables the weld spatter to deposit on the inside wall 56 of the nozzle assembly 50 and on the end face 32 of the contact tip 16, as shown in FIG. 2.

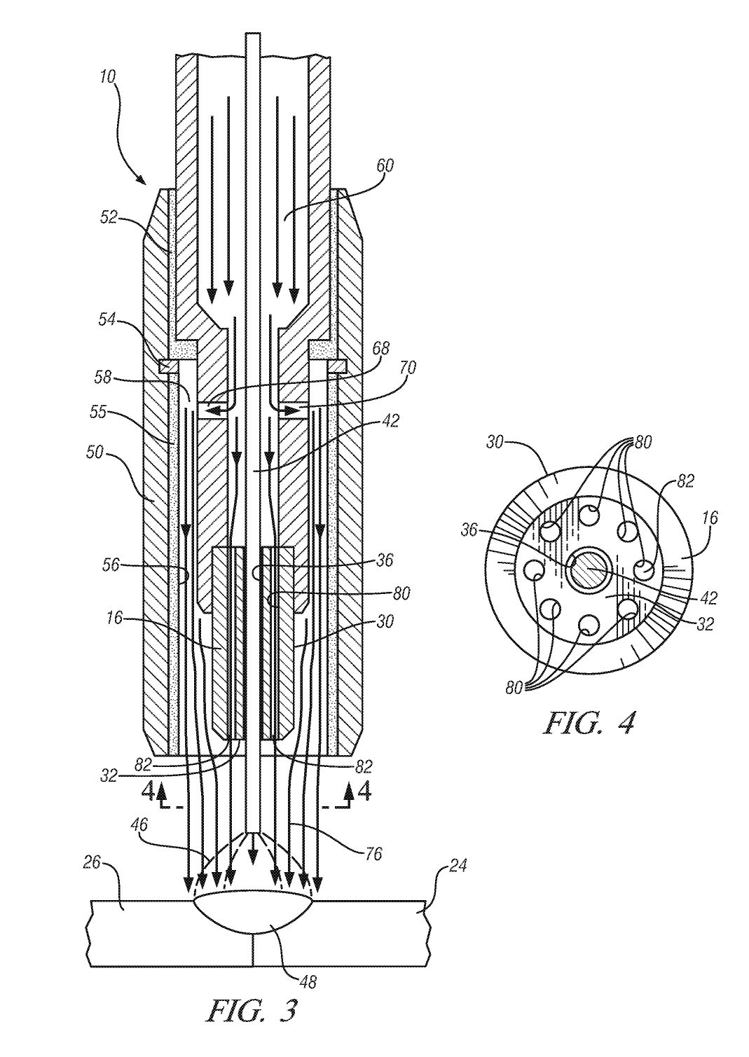

As best illustrated in FIGS. 3 and 4, providing auxiliary gas flow passages within the cylindrical body of the contact tip 16 will improve the flow of shielding gas by reducing the vortices 78 and minimizing the occurrence of any low pressure region at the end face 32 of the contact tip 16 which had heretofore induced the buildup of weld spatter.

In particular, FIGS. 3 and 4, which have reference numerals identical to FIGS. 1 and 2, show a plurality of auxiliary passages 80 that extend lengthwise through the cylindrical body of the contact tip 16 in a circular pattern that surrounds the electrode bore 36. Each of these auxiliary passages 80 has an open end 82 in the end surface 32 of the contact tip 16. These auxiliary passages 80 may be formed, for example, by drilling bores that extend axially through the contact tip 16. As seen in FIG. 3, the upper end of these auxiliary passages or bores 80 communicate with the gas inlet 60 of housing 12 so that, in the example of FIG. 3, the shielding gas will flow both in the annular passage 58 between the inside surface 56 of the nozzle assembly 50 and the outside of the contact tip 16, as well as through the auxiliary passages 80 provided in the contact tip 16. Thus, as shown by the flow arrows of FIG. 3, shielding gas exiting the auxiliary passages 80 is flowed closer to the electrode wire 42 than was the case in FIG. 1, and directly through the end face 32 of the contact tip 30, thereby providing pressurized shielding gas to eliminate the low pressure area and vortices that had existed in FIG. 1. By preventing the low pressure area and preventing the vortices 78 which had circulated within that low pressure area, the buildup of spatter is substantially reduced and accordingly it is less often necessary to halt the welding process while the weld nozzle 50 and contact tip 16 are cleaned of spatter.

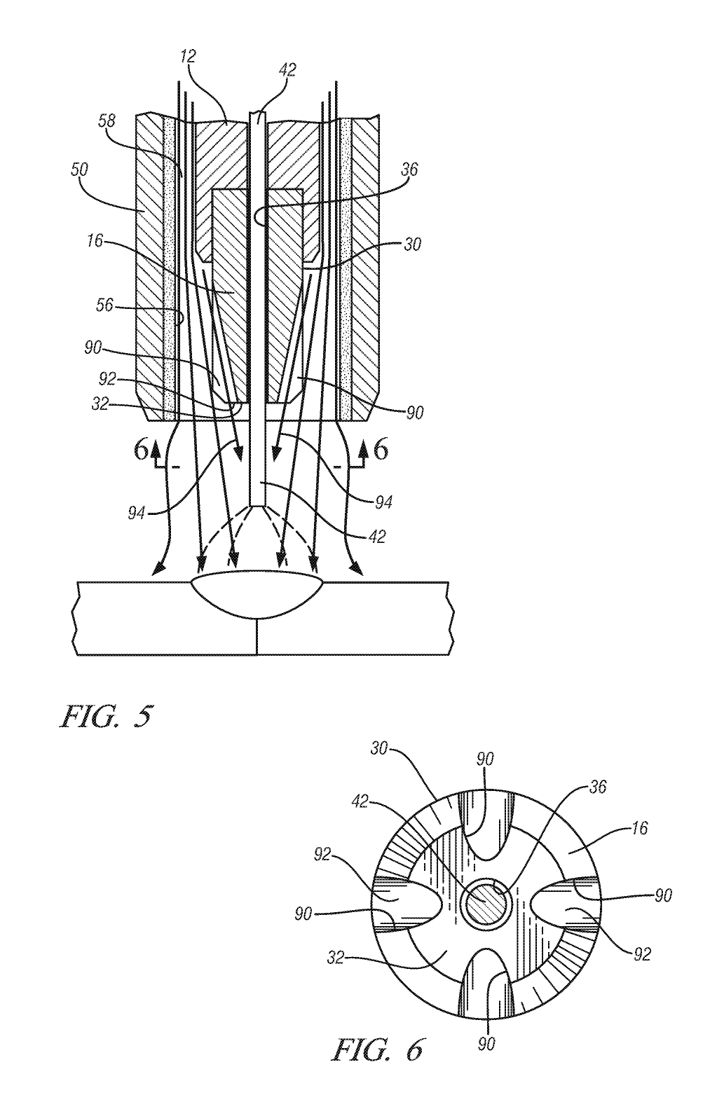

FIGS. 5 and 6 show another embodiment of the invention in which a plurality of flow auxiliary passages 90 are open face channels that are cut into the outer surface 30 of the contact tip 16. In the example of FIGS. 5 and 6, these auxiliary passages 90 become progressively deeper as they progress toward the end surface 32 of the contact tip 16 and are thereby angled somewhat to converge toward the electrode bore 36. Each such auxiliary passage 90 has an open end 92. This angling of the auxiliary flow passages 90 aims the flow of gas in the direction of arrows 94 closer to the electrode wire 42.

The foregoing description of the invention is merely exemplary in nature and thus variations thereof are intended to be within the scope of the invention and will be readily appreciated by a person of ordinary skill in the art. For example, although FIG. 1 shows the passages extending parallel with the electrode wire bore 36, it will be understood that the auxiliary passages 80 of FIG. 3 which are drilled into the body of the contact tip 16, may be angled similar to the angling of the auxiliary passages 90 in the example of FIGS. 5 and 6. Furthermore, although FIG. 5 shows the passages 90 cut into the outer surface 30 are extending at an angle, the passages could be parallel channels cut into the outer surface of the contact tip with out angling toward the electrode wire 42. In addition, it will be understood and appreciated that the relative size and number of auxiliary passages that surround the electrode wire 42 can be varied as needed to eliminate the occurrence of a low pressure area and the resulting vortices.

Although the drawings herein show the example through which the shielding gas is communicated to both the annular gas passage and the auxiliary passages, other inlet and communicating arrangements could be readily devised for connecting the annular gas passage and the auxiliary gas passages to the tank of shielding gas.

Thus, it is seen that the invention provides a new and improved welding torch, and contact tip therefor which effectively reduces the buildup of weld spatter and thereby improves the efficiency of the gas metal arc welding process.

The description of the invention is merely exemplary in nature and, thus, variations thereof are intended to be within the scope of the invention.

What is claimed is:

1. A torch for gas metal arc welding a workpiece comprising:
a torch housing;
a contact tip mounted on the housing and having an electrode bore through which an electrode wire is fed toward the workpiece;
a nozzle mounted on the torch housing and surrounding the contact tip in spaced relation therefrom to define an annular gas flow passage between the contact tip and nozzle;
a shielding gas inlet by which a shielding gas enters the annular gas flow passage and flows out of the nozzle toward the workpiece;
and a plurality of auxiliary passages provided in the contact tip and communicating with the shielding gas inlet, said auxiliary passages having open ends arranged around the electrode bore of the contact tip to surround the electrode wire, whereby shielding gas flow is provided through both the nozzle and the contact tip.

2. The torch of claim 1 further comprising the auxiliary passages being provided by a plurality of bores provided in the contact tip.

3. The torch of claim 2 further comprising the plurality of bores extending parallel with the electrode bore.

4. The torch of claim 2 further comprising the plurality of bores extending at an angle with respect to the electrode bore and converging toward the electrode bore.

5. The torch of claim 1 further comprising the contact tip being cylindrical in shape and having an outer surface, and the auxiliary passages are open face channels in the outer surface.

6. The torch of claim 5 further comprising the open face channels extending parallel with the electrode bore.

7. The torch of claim 5 further comprising the open face channels extending at an angle and converging toward the electrode bore.

8. An improved contact tip for a gas metal arc welding torch having a shielding gas nozzle surrounding the contact tip, comprising:
a cylindrical body of metal having a central bore through which an electrode wire is to be fed and a cylindrical outer surface that is spaced from the nozzle to define therewith an annular gas flow passage;
and a plurality of gas flow auxiliary passages provided in the cylindrical body of metal to provide supplemental gas flow effective to prevent occurrence of a low pressure area at the end of the contact tip and resultant spatter accumulation.

9. The torch of claim 1 further comprising the auxiliary passages being provided by a plurality of bores provided in the contact tip.

10. The torch of claim 2 further comprising the plurality of bores extending parallel with the electrode bore.

11. The torch of claim 2 further comprising the plurality of bores extending at an angle with respect to the electrode bore and converging toward the electrode bore.

12. The torch of claim 1 further comprising the contact tip being cylindrical in shape and having an outer surface, and the auxiliary passages are open face channels in the outer surface.

13. The torch of claim 5 further comprising the open face channels extending parallel with the electrode bore.

14. The torch of claim 5 further comprising the open face channels extending at an angle and converging toward the electrode bore.

15. A torch for gas metal arc welding a workpiece comprising:
a torch housing;
a cylindrical contact tip mounted on the housing and having a cylindrical outer surface and an end face;
an electrode bore extending axially through the contact tip and having an opening in the end face thereof through with an electrode wire is directed toward the workpiece;
a nozzle surrounding the contact tip in spaced relation therefrom to define an annular gas passage between the outer surface of the contact tip and nozzle;
a shielding gas inlet by which a shielding gas enters the annular gas passage and flows out of the nozzle toward the workpiece;
and a plurality of auxiliary passages provided in the contact tip and communicating with the shielding gas inlet, said auxiliary passages having open ends in the end surface of the contact tip and surrounding the electrode bore;
whereby shielding gas flow is provided through both the nozzle and the contact tip.

16. The torch of claim 15 further comprising said auxiliary passages being a plurality of axially extending bores provided in the contact tip and extending parallel with the electrode bore.

17. The torch of claim 15 further comprising said auxiliary passages being a plurality of bores provided in the contact tip and extending at an angle with respect to the electrode bore and converging toward the electrode bore.

18. The contact tip of claim 15 further comprising said auxiliary passages being open face channels in the outer surface of the contact tip.

19. The contact tip of claim 15 further comprising said auxiliary passages being axially extending open face channels in the outer surface of the contact tip, said open face channels having open lower ends that surround the electrode wire.
